(19) United States
(12) Patent Application Publication
(10) Pub. No.: US 2008/0011062 A1
(43) Pub. Date: Jan. 17, 2008

(54) DEVICE WITH INSERT FOR ANALYTICAL SYSTEMS

(75) Inventors: Emad Sarofim, Hagendorn (CH); Hans-Peter Wahl, Schopfheim (DE)

Correspondence Address: TOWNSEND AND TOWNSEND AND CREW, LLP, 2 EMBARCADERO CENTER, 8TH FLOOR, SAN FRANCISCO, CA, 94111, US

(73) Assignee: Roche Molecular Systems, Inc., Alameda, CA (US)

(21) Appl. No.: 11/776,367

(22) Filed: Jul. 11, 2007

(30) Foreign Application Priority Data
Jul. 14, 2006 (EP) EP06014677

(51) Int. Cl. G01N 1/28

(52) U.S. Cl. 73/64.56

(57) ABSTRACT

A analytical device comprising a body comprising a fluidic unit comprising a first chamber having an outlet opening and a first channel exiting said outlet opening, wherein said first chamber further contains an insert comprising recesses between ribs touching the walls of said first chamber and a second channel, said insert being located in a first position wherein said insert is not engaged with said outlet opening, said insert being moveable from said first position to a second position within said first chamber, wherein said insert is engaged with said outlet opening such that said second channel extends said first channel into said first chamber and in the part pointing towards said outlet opening resembles the shape of said first chamber.

### CROSS-REFERENCES TO RELATED APPLICATIONS

The present application claims the benefit of EP Appl. No. 06014677, filed Jul. 14, 2006, the entire contents of which is hereby incorporated herein by reference in its entirety.

### FIELD OF THE INVENTION

The present invention relates to a fluidic device for analysis of a fluid, said device having a first and a second chamber and a channel leading from said first chamber to said second chamber, a method of use of said device, an instrument for analyzing fluids using said device and a system including said device and said instrument.

The field of application of the fluidic device according to the invention is mainly in analytics of fluid, for instance in health care, for the analysis of nucleic acids. Analyses performed using this device are considerably improved, as it avoids imprecision caused by contaminations.

### BACKGROUND OF THE INVENTION

Particularly in analytical laboratories there is a great interest in conducting analyses in a convenient, safe and reliable way. Particular problems are the carry-over from one reagent to another reagent. Therefore devices have been proposed for the analysis of a sample and/or reagents that minimize the contamination of subsequent reagents in a sequential procedure.

In EP 318 256 there is shown a device comprising a chamber through which the fluid is forced. This device cannot perform more than one analysis.

In WO 93/22058 there is disclosed a device having a few chambers each having different temperatures. The fluid flow in this device is complicated.

### BRIEF SUMMARY OF THE INVENTION

It was an object of the present invention to provide a device with improved properties over the devices according to the prior art, particularly a device allowing a simple fluid flow with no carry-over of different reagents of the sample preparation steps into the final measuring mixture, as in immunoassays and PCR amplification techniques.

A first subject of the invention is an analytical device comprising a body with a fluidic unit comprising
a) a first chamber having an outlet opening, and
b) a first channel exiting said outlet opening,
   wherein said first chamber further contains an insert comprising a second channel, said insert being located in a first position wherein said insert is not engaged with said outlet opening, said insert being moveable from said first position to a second position within said first chamber wherein said insert is engaged with said outlet opening such that said second channel extends said first channel into said first chamber.

A second subject of the invention is an analytical instrument comprising
a fitting for holding a device according to the invention in any of its embodiments, and
a head comprising an actuator reaching into the device and having a freedom to move the insert from said first position to said second position.

Another subject of the invention is a system for analysis of a fluid in a device, comprising
a device according to the invention in any of its embodiments, and
an instrument according to the invention.

Another subject of the invention is the use of a device according to the invention in any of its embodiments for the analysis of a fluid.

Still another subject of the invention is a method of analysis of components of a fluid comprising
providing a device according to the invention in any of its embodiments or a system according to the invention in any of its embodiments, and
introducing a fluid into said first chamber,
releasing said component of said fluid from other components of said fluid this component is associated with in said first chamber,
transferring the resulting fluid through said outlet opening and said first channel into said second chamber, said second chamber containing a solid phase for immobilization of said component to be analyzed, thereby binding said component to said solid phase,
moving said insert towards said outlet opening into said second position such that fluid can pass said insert towards said outlet opening through said second channel and can pass said recesses, but cannot enter into said first channel when having entered said recesses, and
introducing a second fluid into said second chamber through said second channel.

### BRIEF DESCRIPTION OF THE DRAWINGS

In FIG. 1a a first device according to the invention is shown in a status wherein the moveable insert in the first chamber is in a first position, allowing free exit of fluid from the chamber into the first channel, both through a channel in the insert and through recesses between the insert and the wall of the bottom part of the chamber. The device contains 8 parallel analytical units, each being equipped with the insert. The chamber and the insert are shown in cut view. Reference numerals are as follows: device according to the invention (1); insert (2); first chamber (3); outlet portion (4); second channel (5); first channel (6); rib (7); recess (8); and second chamber (9).

FIG. 1b shows the same device in a second position, allowing exit of fluid only through a channel in the insert into the first channel, not between the insert and the bottom of the chamber.

FIG. 2a shows an enlargement view of the insert as located in the first position, in full view.

FIG. 2b shows an enlargement view of the insert as located in the first position in cut view.

FIG. 2c shows an enlargement view of the insert as located in the second position, moved to the bottom of the chamber, in cut view.

### DETAILED DESCRIPTION OF THE INVENTION

The device of the present invention is useful for a fluid action commonly performed or desirable, during treatment of fluids, such as physical treatment and chemical treatment of fluids, particularly in the field of analytics. Due to the present invention, even complex fluidic methods are made possible. However, even for simple steps the present invention provides advantages. In an embodiment, more than one fluid can be treated in parallel.

A fluid that can be treated according to the present invention can be any fluid that is of interest to be subjected to a particular treatment. In some embodiments, the fluid is a liquid. In certain embodiments, the liquid is an aqueous solution. In certain uses of the device according to the invention, components of the liquid or compounds derived there from are intended to be analyzed. In a diagnostic device, the liquid contains components to be determined in an analysis, e.g., nucleic acids or antigens. Such liquids may be selected from the group of liquids from the environment, like water from a river or liquids extracted from soil, food fluids, like a juice or an extract from a plant or fruit, or a fluid received from a human or animal body, like blood, urine, cerebrospinal fluid or lymphatic fluid, or liquid derived there from, like serum or plasma, or liquids containing components to be isolated from the before mentioned liquids. The liquid may further contain additional components useful for the analysis of components of the liquid or reagents for chemical reactions to be performed within the device. Those reagents can comprise labeled binding partners, for instance labeled oligonucleotide probes or dyes. Such reagents are generally known to those skilled in the art.

The device according to the invention comprises at least one fluidic unit. The fluidic unit at least comprises one chamber and one first channel. In the following a fluidic unit is understood to be a construction of cavities in a device which are interconnected such that a fluid introduced into one of said cavities can flow into another cavity of said construction or can be forced to flow into another cavity of said construction. For example, in the simplest case this is achieved by that the chamber and the channel are connected to each other, so that a fluid from the chamber can be forced to enter said channel. In case multiple analyses of different samples are to be performed in the same device, the device can contain more than one fluidic unit. In this case, each fluidic unit has a fluidic behavior which is independent from the individual fluidic behavior of other fluidic units in the device.

Devices comprising a chamber and a channel are known. Also devices having more than one chamber and/or more than one channel are known. However, those prior art devices suffer from the problem that any fluid introduced after a first fluid through the same chamber gets contaminated by remainders of the first fluid remaining in the chamber. The present invention solves this problem, especially for cases where the first chamber has a much larger volume than the subsequent second or third chamber irrespective of how many other chambers or channels are arranged in the fluid path after the first chamber.

Manufacture of devices having at least one chamber and at least one channel exiting said chamber(s) are also well known. Such devices can readily be prepared by injection molding methods using thermoplastic organic materials. In this case, any moulds are constructed such that the chambers and channels remain free of material through said molding process. Other methods, such as working a solid block of material to remove space for the chamber and channel are available.

A device according to the invention contains at least one body. A body is a part of the overall device that mainly provides stiffness or rigidity to the device. Therefore, the body may be is rigid. In some embodiments, the body is formed from a thermoplastic material, for example, from a material selected from thermoplastic organic polymers. In certain embodiments the thermoplastic organic polymer is selected from the group consisting of polypropylene, polyethylene, polystyrene, polycarbonate and polymethylmethacrylate. In some embodiments, the material may be, at least at parts for analysis, light transparent. The body may have a length of between 20 and 199 mm, a breadth of between 8 and 30 mm and a height of between 40 and 150 mm, dependent upon the amount and kind of treatment steps to be performed in the device. Usually, the more fluid(s) is (are) to be analyzed, the larger the volume of the body.

A channel according to the invention is a cavity in the device which has a longitudinal dimension that is larger than its width and height. The channel can be confined by walls defining the width and height of the channel. In some embodiments, a wall of the channel is defined by the surface of a groove formed in the body of the device and a surface of a wall closely sealed to the edges of the grooves of the body. Channels formed within the device may have a cross section of less than 10 mm², in some embodiments of between 0.01 and 2 mm². Channels for transporting fluids through the device may have smaller dimensions than chambers for keeping the fluids and/or performing a process, such as a chemical reaction.

The use of a channel can be various, e.g.
delivery of fluid between two locations within the device (e.g. chambers),
delivery of fluid in or out of the device,
measuring fluid, and/or
processing a fluid or processing matter being solved or suspended in the fluid.

A chamber according to the invention is another kind of cavity in the device. The dimensions of said cavity will vary upon the intended use of said chamber. The use of a chamber can be various, e.g.
storing, receiving, and/or delivering fluid, e.g. a sample or a reagent,
processing a fluid, e.g. for analysis of matter in the fluid, and/or
measuring a physical of chemical property of a fluid (e.g. for performing optical absorption or fluorescence measurement).

The first chamber of the device of the invention is a chamber particularly adapted to the insert contained in said chamber. As a first feature, the first chamber has an outlet opening. This opening is designed to allow fluid to exit said chamber. That fluid is then received by a channel exiting the chamber. That channel can be a channel as described above. It can lead to any other location in side said device, for example in said device, for example, a cavity in said device.

The channel fits in shape to the outlet opening of the chamber, such that it can receive fluid from said chamber through said opening.

According to the invention said first chamber further contains an insert comprising a second channel, said insert being located in a first position wherein said insert is not engaged with said outlet opening, said insert being moveable from said first position to a second position within said first chamber wherein said insert is engaged with said outlet opening such that said second channel extends said first channel into said first chamber.

The movement of the insert from the first to the second position can be achieved by forcing the insert to change its position in the device. This can be achieved by any force, for example mechanically, electrically or magnetically. The insert can slide along a path from the first to the second position.

This arrangement of the insert in the second position allows the person/or the instrument to introduce a second fluid into the first channel after a first fluid has passed the chamber selectively without contaminating the second fluid by remainders of the first fluid. Thus, small leftovers of the solution which have passed through said first channel cannot enter into said first channel when being forced to the bottom of the first chamber, e.g. by gravity or by vibration of the system, but are caught in the recesses which are closed now in the second position.

This is done by introducing the fluid into the channel into the insert, the second channel, which leads to the first channel. Any amounts of first fluid still present from earlier treatment steps remain in the first chamber especially in the recesses between the wall of the first chamber and the insert, as they cannot pass the second channel extending into the chamber.

To achieve this, one or more, or even all of the following measures can be taken.

In a first measure, the interior of the first chamber in the area around the outlet opening and the shape of the insert should be adapted to seal the connection between the first and the second channel. In some embodiments, the shape of said insert in the part of the insert pointing towards said outlet opening resembles the shape of the first chamber. In other embodiments, the outlet opening broadens conically from said first channel into said first chamber and said insert conically narrows, optionally with the same angle. This angle may be selected to be between 5 and 85°, or between 20 and 60°, versus the axis of flow out of the outlet opening, which may be identical to the direction of the first channel exiting the chamber.

The sealing area may be as small as 10 mm², but may be between 20 and 314 mm², or between 40 and 77.5 mm².

In a second measure, the insert further comprises recesses between ribs touching the walls of said first chamber. Thus, when said insert is in said first position, fluid can through said second channel and through said recesses pass said insert into said first channel through said outlet opening. On the other side, when said insert is in said second position, fluid can pass said insert towards said outlet opening through said second channel and can pass said recesses, but cannot enter into said first channel when having entered and/or passed said recesses.

In the third measure, ribs are located at the part of the insert touching the interior of the first chamber. The ribs provide for exact positioning of the insert in the chamber. In order to improve this positioning, the part of the chamber in which said insert is moveable and which is in contact with the ribs has a constant diameter over the path of movement of the ribs of the insert. This diameter is selected such that there is a constant pressure on the insert, high enough to hold the insert at a defined position, but small enough to allow the operator to move the insert along its predetermined path. This can be achieved by using plastic material for the chamber wall and the insert, particularly in the part of the ribs. In an injection molding process, the form of the mold giving the chamber its interior shape should be chosen slightly smaller than the form of the mold giving the outer form of the ribs its shape.

The form of the part of the chamber in which the insert is guided with the help of the ribs may have any form that allows the insert to move. In some embodiments, the diameter of the part along the path of movement is simple, for instance circular, rectangular or square. This is mainly due to easier manufacturing, so any other form may also be possible.

In an alternative embodiment, the wall of the chamber comprises said recesses and ribs. In this case, the insert can have a cylinder-like form, the perimeter of which is larger than the inner diameter of the chamber.

In yet another embodiment, both the chamber and the insert have ribs and recesses. This is believed to improve the guiding characteristics of the chamber for the insert.

There may be between three and 20, or between 4 and 10 ribs around the perimeter of the insert. Between the ribs there are the recesses. Those recesses may take any form to allow first fluid to be caught in said recesses. They may look similar or may be different.

In a first embodiment, the outer shape of said insert resembles the shape of said first chamber except for the top of the insert. Said top has a circular collar which is conical increasing from the outer border of the device towards the middle and is increasingly conical from the inner second channel so that a brim is formed on the top of the insert, the brim having a distance from said outer wall so that drops of the remaining fluid at the outer wall is trapped between the brim and the outer wall because of the height of the drop is smaller than said distance.

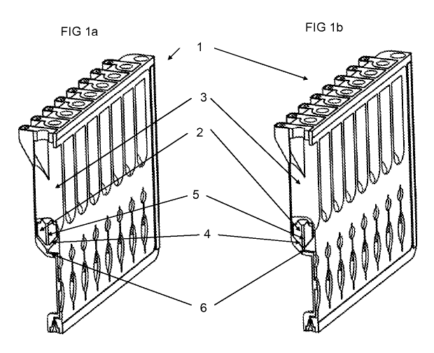

In a further embodiment, additional recesses are formed between the outer wall of the insert and the inner wall of said first chamber forming at least 3, up to 20 ribs to keep the body of the insert away from the inner wall if the first chamber, and to reduce the force to move said insert from it first position to the second position. The top of the insert is equipped with said conical collar but this time the collar dose not reach the inner wall of said first chamber FIG. 1c.

The volume of fluid that cannot enter the outlet opening of said first chamber when said insert is in said second position can be between 10 and 500 μl. This is sufficient to retain drops of fluid that had adhered to the walls of the first chamber from the earlier treatment and would contaminate the second fluid, if they were to enter the fluid stream through the device together with later added fluids.

The shape of the insert may further be influenced by the particular use of the insert. For example, in certain embodiments, the shape of the insert pointing towards the inlet opening of the chamber comprises a conical part at the end of the second channel pointing away from said outlet opening. This will allow better interaction of the insert with the actuator for moving the insert on its movement path towards the outlet opening. Furthermore, the conical form may help guide the second fluid into the second channel.

The overall size of the insert may depend upon the size of the first chamber. In some embodiments, the diameter of the insert will not be larger than the largest diameter of the chamber, if the insert is slightly larger in diameter, for example 0. 1 to 0.3 mm, the insert is made of elastic material to guaranty a perfect match of the insert in said first chamber. In some embodiments, the dimension for the diameter of the insert is between 0.1 mm and 10 cm, or between 0.2 mm and 20 mm. The length of the insert may be between 0.1 mm and 10 cm, or between 0.1 cm and 3 cm. The length of the ribs along the path of movement may be between 0.1 mm and 5 cm, or between 0.2 mm and 3 cm.

The inner wall of said first chamber is equipped with at least one, and in some embodiments with the same number of bars, which hold the insert in said second position even when the force between the pipette tip which moves the insert form said first position to said second position is larger than the sliding force with which said bar holds the insert in the position. Thus, the pipette can not pull the insert out of the second position because said bar(s) will prevent the insert from moving back.

The length of the second channel may be between 0.1 mm and 10 cm, or between 1 mm and 5 cm. The channel may be tubular, but may also contain conical parts, for example at the part designed for interaction with the actuator.

In some embodiments, the invention comprises an actuator to move the insert within the device from a first position to a second position. This can be achieved by different means in the device or outside the device. In some embodiments, the actuator is a device contained in an instrument for handling the device. Then the actuator may be constructionally independent from the analytical device. In this case, the device according to the invention may have an opening through which the actuator can enter the interior of the first chamber to push the insert towards the outlet opening of the chamber. This opening may be the opening through which the fluid was introduced into the chamber. In some cases, this opening is the upper opening of the chamber.

In a first use, the chamber will be used to receive a sample having a large volume, e.g. for performing a lysis reaction in the original sample, adding a certain volume of reagent fluid. The volume of a chamber may be less than 1 L, or between 1 μl and 100 ml. One embodiment of such chamber is a chamber for chemical sample preparation, such as the lysis of cellular components of a fluid containing cells to release constituents of said cells, e.g. nucleic acids. Such chamber may be called a lysis chamber. A lysis chamber does not need to be a flat chamber, but may have an at least partially tube like form, having an upper opening for introducing a sample and reagents for lysis, and a lower opening as an outlet to a channel. Conditions under which chemical sample preparation is performed are well known and can be applied to the present invention easily.

In certain cases, the fluidic unit according to the invention additionally comprises a second chamber. This chamber is fluidically connected to the first chamber by said first channel. A fluidic unit may contain even more channels and/or chambers, e.g. for further transport of fluids to other chambers in the interior of the device or for further treating fluids in the device.

In some embodiments, useful for the determination of nucleic acid analytes in fluids, each fluidic unit contains a first chamber, i.e. a lysis chamber and a first channel leading from the outlet portion of said first chamber to a second, optionally flat, chamber, optionally via an inlet portion, said second chamber comprising a fleece capable of reversibly binding nucleic acids. A third channel leads from an outlet portion of said second chamber to a third chamber, optionally via an inlet portion of said third chamber, and a fourth channel leads from an outlet portion of said third chamber to an outlet port of said device. Any of those chambers can be a chamber according to the invention. The chamber may be a lysis chamber and may be the first chamber according to the invention.

In other embodiments, the fluidic unit further comprises a third channel leading from said second chamber to a third chamber for irradiation and detection.

The last channel, in the above embodiments the fourth channel, in the fluid path is leading out of the device through an outlet port. An outlet port in the device of the fluidic unit, is an opening of the device designed to allow the fluid to exit the device in a controlled manner, while avoiding unintended escaping of fluid during treatment. Thus, in some embodiments the opening is sealed, for instance by a stopper, which can be pierced by a hollow needle.

The device according to the invention may comprise as many fluidic units as meaningful. A too large number may be disadvantageous in view of then more difficult handling of the device. For instance this may require too many actuators in an instrument to be fluidically accommodated. It has proven to be advantageous to use from 2 to 16 fluidic units in one device, or between 4 to 8 units.

In order to handle the device conveniently, the fluidic units may be arranged in a parallel mode. This means that the positions of the chambers and channels of different fluidic units geometrically parallel each other. Any inlet and outlet ports will then be located at the same side of the device, in some cases one kind of port, e.g. the inlet ports, along an edge of the device, the other kind, e.g. the outlet ports, being located along another edge. If there are two different kinds of inlet ports, they may be arranged at the same side or edge of the device.

The form and size of the overall device according to the invention is mainly determined by the function to be served by the device. Furthermore, the kind and amount of the fluid in said device and the kind and number of steps to be performed may further determine the geometric and functional characteristics of the device.

The fluidic devices as disclosed herein have one or more channels with a cross section of more than 0.1 μm², or between 10 μm² to 10 mm². The devices may further or alternatively comprise one or more chambers having a larger cross section larger than the channels. A chamber of a fluidic device may have a volume of between 10 μl and 3 ml, or between 1 μl and 5 ml.

The device according to the invention can comprise additional elements, such as recesses and protrusions for interacting with an instrument for receiving and/or treating said device.

The device may contain grooves to engage with a gripper to grip the device and transport it to a position in the instrument and secure it at a predefined position.

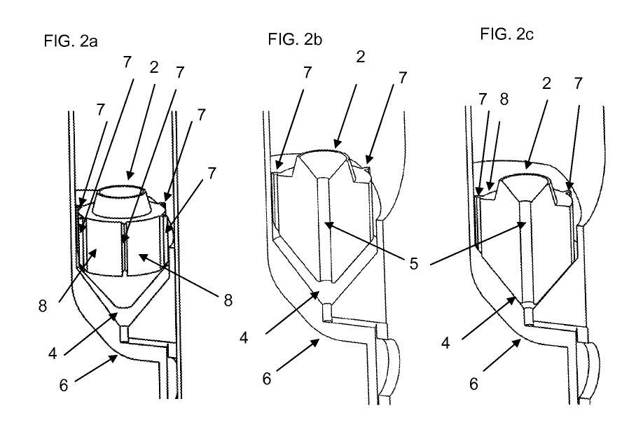

A first embodiment of a device according to the invention is shown in FIG. 1a. The device according to the invention (1) is shown in a status wherein the moveable insert (2) in the first chamber (3) is in a first position, allowing free exit of fluid from the chamber into the first channel (6), both through the second channel (5) in the insert (2) and through recesses between the ribs of the insert and the wall of the bottom part/outlet portion (4) of the chamber (3). The ribs and recesses of this situation are shown in more detail in FIG. 2b. The device contains 8 parallel analytical units, each being equipped with the insert. The chamber and the insert are shown in cut view.

FIG. 1b shows the same device (1) in a second position, allowing exit of fluid only through a channel (5) in the insert (2) into the first channel (6), not between the insert (2) and the bottom (4) of the chamber (3).

FIG. 2a shows an enlargement of the lower part of the first chamber with the insert (2) being in the first position with the insert being shown in 3D view, while FIG. 2b shows the same situation in cut view and FIG. 2c shows the same with the insert in the second position. In each there is shown the first channel (6), the bottom part (4), the recesses (8), in this case 6 recesses around the perimeter of the insert (2), some being hidden, the ribs (7) and the second channel (visible only in cut view).

In some embodiments, the device according to the invention is a composite of the body and at least one sealing wall. In this case, any cavities in the body, despite the cross section of channels through which fluids can enter and/or leave the chamber and the inlet and outlet ports of the device, are closed by a sealing wall attached to the body.

In some embodiments, the body has an area that is generally flat over an area of between 1600 and 19200 mm², or of between 7200 and 12000 mm². This area is referred to herein as “the sealing area”. The term “flat” means that the body towards the outside of the device is as geometrically homogenous as is required to allow a sealing unit to approach and thermally contact the body such that sufficient heat can be applied to the material of the body to melt a part of the body in contact with the sealing unit. In other parts, the body may contain areas that rise from the flat surface, e.g. in the vicinity of chambers formed in the body.

A sealing wall may be a generally flat piece of material. It may be made from one material or may be a composite. In some embodiments it has the form of a foil which is less rigid than the body. The has applicants have found that it is very advantageous, if the sealing wall is a composite of the same thermoplastic material as the body—this part being called the thermoplastic part—and a carrier part made of a material having a melting temperature which is higher than the melting temperature of the thermoplastic part. In some embodiments, the carrier part is selected to provide tear strength to the sealing wall. Said tear strength is important for the reliability of the sealing process. The tear strength may be between 5 and 50, or between 6 and 40 N/mm². In some cases, the material for the carrier part is selected from the group of metal foils; in certain embodiments the material comprises aluminum. The thickness of the foil may be between 40 and 400 μm.

In some embodiments, the sealing wall is a heat-transfer wall. A heat-transfer wall may comprise a heat-transfer material, i.e. a material having good heat conductivity. Heat-transfer materials may be selected from the group of aluminum and copper. In some embodiments, the heat-transfer wall comprises 2 layers. In some cases, one of said layers is a metal layer and a second layer is a thermoplastic layer, and said layers are welded together.

In order to insure proper, particularly liquid tight, sealing of the sealing wall to the body in the area surrounding the cavity, the sealing wall may be substantially planar. Substantially planar means that it is flat over more than 80%, or more than 90% or 100%, of its surface. The part of the body intended for sealing to the sealing wall should be substantially planar to a similar extend in the areas surrounding the cavity, but excluding the grooves that are intended to form channels or chambers in the device after sealing.

The sealing wall may be between 20 and 1000 μm thick, or between 50 and 250 μm. In some embodiments, there is one sealing wall per body of the device, covering all grooves to be sealed in the body.

Between those components at least one cavity is formed in said fluidic unit. A cavity comprises at least one chamber and at least one channel. A fluidic unit according to the invention thus requires at least one chamber, called the first chamber, and at least one channel, called the first channel. This fluidic unit is located at a position of said device, for instance at the beginning of a fluid path, which is accessible by an actuator from outside the device such that the actuator can enter the interior of the chamber.

The two parts—body and sealing wall—can be joined by known methods. In certain embodiments, wherein the sealing wall is a thin wall comprising a thermoplastic polymer and the rigid body is made of polymer, e.g. polystyrene, the two parts can be combined and then sealed by welding, e.g, by LASER welding, ultrasound welding, thermo sealing or gluing. The two parts can also only be clamped or stick together.

The joining method, the material of body and the material of the sealing wall are selected to fit together (i.e., complement each other). For example, if the joining method is LASER welding, then the bulk material of the body and the sealing wall are of the same material (e.g. polypropylene) but one of the two materials is stained to have absorption for the Laser energy. If the joining method is ultrasound welding both materials are typically the same. If the joining method is thermo sealing the sealing wall is a thermo sealable wall adapted to thermally seal to the body.

In the above method for manufacturing, further assembly steps can be added, particularly, if the device contains additional elements.

Another subject of the invention is an instrument comprising
a fitting for holding a device according to the invention or any of its embodiments, and
a head comprising an actuator reaching into the device and having a freedom to move the insert from said first position to said second position.

In order to reliably hold and apply instrumentation to the device, the instrument comprises a fitting for holding the device. This fitting also allows holding the device in a position wherein the fluid can be introduced into the fluidic unit of said device at the time as wanted. The fitting may be adapted to the outer form of said device as much as desired to keep the device. The fitting may include a snap-in means that have a form fit to respective parts of the device. Such form fit may be provided by protrusions in said fitting that can be inserted into recesses in the device, or vice versa.

Furthermore, the instrument according to the invention comprises a head comprising an actuator reaching into the device and having a freedom to move the insert from said first position to said second position. An actuator in the sense of the invention is a device having the rigidity to push the insert from the first position to the second position. There is no need to move the insert back by drawing forces. In one embodiment the inner wall of said first chamber has bars that hold the insert in said second position. A actuator according to the invention may be a pipette tip mounted to a socket on a pipettor. It is possible to simply push the insert towards the outlet opening using the used pipette tip of the present pipetting step, for example, the first dispensing step of the washing procedure. The computer program controlling the process steps needs to be adjusted to in addition move forward to push the insert towards the second position.

The instrument according to the invention may comprise devices to fulfill function of dispense or deliver and remove or receive fluids to and from the device is to be considered both as active and passive handling. For example, receiving a fluid from a first fluid handling unit can be made by either applying the fluid under pressure to the device to press the fluid into the device or by applying negative pressure to the cavity so as to suck fluid into the device and removing or delivering fluid from the device to the outside can be achieved by either applying pressure to the cavity, e.g. by pumping a fluid, such as a liquid or a gas through a first inlet port, or applying negative pressure to the cavity so as to suck the fluid through an inlet port. Appropriate means include syringe pumps. The liquid handling units are situated in the instrument such that they can act on any input and output location when the device is put into a defined position on the instrument. The position of the head relatively to the inlet or outlet port of the device may be controlled by a control unit.

In some embodiments, this instrument is an analytical instrument. Instruments for analysis of a fluid or any components thereof are generally known. They include units as generally known for analyses. Such units may be, for example, optics for determining properties, for instance optical properties, or changes in properties of the fluid contained in the device, mechanics to move the fluid from a first position to one or more other positions, and liquid handling units for dispensing and/or aspirating fluids from tubes, vessels or reagent containers into the device. As pointed out above, the instrument comprises a head, which is used to dispense fluids into the fluidic units of the device according to the invention and/or remove liquids from the device.

The instrument may further contain a heating and/or cooling element. This element is positioned such that it contacts or can contact the device at the outside of the sealing wall, as in when the fluid is contained in a chamber within the device, such that a heat transfer to and from the heater and/or cooler to and from the chamber is possible, e.g, through said heat-transfer wall. An example of an instrument comprising a heating and/or cooling element is a thermocycler. Thermocyclers are generally known to apply a profile of different temperatures in repeated manner to a fluid. An exemplary thermocycler is described in EP 0 236 069. Heating and/or cooling elements may be selected from the group consisting of a Peltier element, a resistance heating element and a passive cooling element, such as a metal block equipped with a fan.

In the present invention, for each fluidic unit there may be at least one thermal cycler unit, each being located in the instrument in a position that be moved relative to the device to contact said sealing wall close to the chamber containing the fluid to be heated. In some cases, this is the third chamber as pointed out above. Each thermal cycler may be regulated independently, i.e. each thermal cycler can be applied with a different thermal profile. A thermal profile is defined by the temperature to be reached in the chamber and the length of time to keep this temperature. The different profiles can be achieved by computer control. The interruptions provided on the device facilitate the possibility to use different thermal profiles at adjacent fluidic units.

In order to perform monitoring of properties or change of properties of the liquid during processes performed in the device, the instrument further comprises a property monitor unit optically connected to transparent walls of a chamber in said fluidic units, e.g. a detection module. For example, if the property is a change in an optical signal, for example a fluorescent signal, the detection module will comprise a light source positioned in the instrument such that the fluidic units of the device, e.g., a detection chamber in that device, such as the fourth chamber, can be irradiated, and an irradiation receiving unit, e.g. a light sensitive cell for receiving irradiation from the fluids contained in the device and transmitting an electrical signal to an evaluation unit. The detection module is located in the instrument where it can detect light emanating from the fluids contained in the chambers. If there is also an irradiation module located to impinge light into the chamber, this light can have characteristics to either excite a component in the fluid, either to be absorbed or to be altered.

If the process to be performed in the device requires connectivity of components of the device, such as electrodes or heating walls in the device to an electric circuit of the instrument, such connectors may be provided on the instruments on positions that are located such that the connectors on the instrument are connected to their counterparts on the device, when the device is inserted into the instrument.

Another subject of the present invention is a system for analysis of a fluid in a device, comprising
a device according to the invention in any of its embodiments, and
an instrument according to the invention in any of its embodiments.

The system according to the invention may additionally comprise a fluid container (e.g. for waste collection) and/or one or more reagent containers.

A further subject of the invention is the use of a device according to the invention in any of its embodiments in a method for analysis of a sample.

Therefore, another subject of the invention is a method of analysis of components of more than one fluid comprising
providing a device according to the invention in any of its embodiments or a system according to the invention in any of its embodiments, and
introducing a fluid into said first chamber,
   releasing said component of said fluid from other components of said fluid this component is associated with in said first chamber,
   transferring the resulting fluid through said outlet opening and said first channel into said second chamber, said second chamber containing a solid phase for immobilization of said component to be analyzed, thereby binding said component to said solid phase,
   moving said insert towards said outlet opening into said second position such that fluid can pass said insert towards said outlet opening through said second channel and can pass said recesses, but cannot enter into said first channel when having passed said recesses; and
   introducing a second fluid into said second chamber through said second channel.

Said second fluid can be introduced through said second channel and said first channel because in said second position the second channel is directly connected with the first channel.

The fluids, for example, samples to be analyzed and/or reagents, can be introduced into the device according to known methods, e.g. by pipetting the fluids into openings in the fluidic units. In some cases, they are introduced into the fluidic units by a head as outlined above for the instrument, e.g. such as a head carrying pipette tips, through said inlet ports into the first chambers. In these chambers the samples are treated to set the components of the samples to be analyzed free from any cellular compartments the components may be associated with in the samples. For the analysis of nucleic acids, this may include disrupting cells by a combination of chemical treatment with chaotropic salts and a protease to digest cell walls with a physical treatment with heat, e.g. by warming up the lysis mixture to between 37° C. and 87° C. The exact conditions may depend upon the particular type of sample and the lysis solution and/or the enzyme used for the lysis. Some samples may need more harsh conditions than others. In order to achieve lysis, the samples must be brought into contact with reagents for the treatment, e.g. for the lysis. This may be done by pipetting aliquots of each of the samples and the reagents into the chambers.

If no more than the sample preparation is intended to be performed in the device, the process may be completed by removing the pretreated samples from said chambers, for instance by removing the mixtures through the first channels. However, other steps may be added in said device that may or may not include further embodiments of the invention.

If the method according to the invention shall be performed including the analysis within the sample, the method according to the invention after treatment in a first chamber, e.g. after sample lysis, should include transport of the result of the step, e.g. the pretreated sample, into the second chambers for further treatment. This may be done by subjecting the fluids to positive or negative pressure to leave the first chambers through the outlet portions into the first channels. In certain embodiments, the fluids are transferred for purification purposes of components of the samples into second chambers. Any components to be immobilized are bound to porous material contained therein.

Some embodiments of the invention comprises introducing second fluid into said second chambers through said second channel, after the insert was moved into the second position, for example, by an actuator as outlined above. Said second fluid may be selected from the group consisting of a washing fluid and/or an elution buffer and/or master mix. A washing buffer is a fluid that is designed to remove any free components of the fluids from the component(s) immobilized to said porous material. Such buffers are well known in the art and may include salt concentrations lower than the fluid used for immobilization. An elution buffer may contain reagents for the detection of a component of said fluid or a component derived there from. A mixture of an elution buffer and a master mix further contains the reagents for amplification and detection of nucleic acids, such as primers, probes, enzyme and reagents.

For conducting an assay, the method optionally comprises first washing the components immobilized on the porous material and then eluting them from the material.

Then eluates can be led to the third chambers for detection. This can be done by supplying a fluid to the device, e.g. through said second channel. This will force the fluid through the third channel to the third chamber.

The chamber optionally further contains at its end opposite to the inlet portion of the third channel an outlet portion for a fourth channel, said fifth channel leading to another fluid port, the output port.

In some embodiments, there is in each fluidic unit at least one chamber, such as the third chamber as outlined above, designed to allow a step for physical or chemical treating said fluids. Such physical treatment may be a treatment selected from the group of heating and cooling (thermal treatment), mixing and irradiating and any combinations thereof. Any thermal treatment may be performed through any wall of the chamber of said device. In some embodiments, the heating is done through the sealing wall.

In a first embodiment, physical treatment is thermocycling as used in the Polymerase Chain Reaction (PCR, EP 0 201184).

In another embodiment, said first chamber or the third chamber in each fluidic unit is a detection chamber, such as an amplification/detection chamber. In this chamber, a property representative of said component to be analyzed or of a component derived therefrom may be determined as a measure of the presence or absence or the quantity of the component of said original liquid.

Detection may be a two-step process, including irradiation and monitoring. After irradiating the fluid in said chamber a property of the contents of the chamber, i.e. the fluid, is monitored. Said monitoring a property of the fluid may be performed through a wall of the body. The requirements of the monitoring process determine the characteristics of the wall confining the chamber. For instance, determining light emanating from the fluid using a detector unit located outside the device in an instrument requires transparency of the wall for light emanating from the chambers. In this case, the material of the wall will be a material transparent for this light. If said monitoring in addition requires impinging light onto the fluid contained in said chamber through said wall, the material of the wall should be transparent for the impinging light.

Detection can be made by irradiating the liquid in the cavity with light of a wavelength at which one of the components or reagents in the fluid has a measurable absorption. Determination of light leaving the cavity, for example by fluorescence, can be used to determine the absorbance of the liquid or any changes in absorbance of the liquid over time or compared to a standard liquid.

Chemical treatment is the performance of a chemical reaction. In some embodiments, in the third chamber the performance of a chemical reaction is detected. In some cases, the chemical reaction is a reaction modifying the chemical constitution of any component of the fluid or any derivate thereof. Examples of such chemical reactions are primer extension, hybridization, denaturation and lysis. In some embodiments, the chemical reaction is the PCR as referred to above, or its improvements such as homogenous PCR, sometimes also called Real-Time-PCR, as described in EP 0 543 942.

In order to perform combined amplification/detection including the PCR, the content of the chamber is heated and cooled in a cyclic manner. In order to achieve efficient thermocycling the sealing wall covering the third chamber contain a metallic part facilitating heat transfer from the thermocycler into the chamber, a heat transfer foil. Homogenous PCR allows detection nearly from the start of the thermocycles through a transparent window in said body.

In some embodiments of this method of analysis, the component of the liquid to be analyzed is a nucleic acid suspected to be contained in the fluid, for example a part of the genome of hepatitis C virus. The reagents for analysis, such as the elution buffer, will then contain reagents, e.g. primers, for the amplification of a particular fragment of said nucleic acid and a probe for binding to the amplified fragment. An embodiment of such a reaction is disclosed in EP 0 543 942. In order to apply thermal cycles to the fluid contained in the chamber, the instrument used contains a combined heating/cooling block to bring the content of the chamber to the temperatures in a profile as needed to amplify the nucleic acid. The change in absorbance or fluorescence in the fluid is then used as a measure of the nucleic acid to be determined in the fluid.

The reagents used for treatment in the different fluidic units of one device may be the same or may be different. For example, if in the first fluidic unit HBV is to be detected and in the second unit HIV is to be detected, the same procedures and reagents for sample lysis and purification may be used for the two aliquots of the sample in different units, but different reagents for amplification and detection (elution buffer and master mix), reflecting the different sequences to be amplified, should be used. Suitable reagents for sequence specific amplification and detection are known to the man skilled in the art and can be applied analogously.

An advantage of the device according to the present invention is that in a simple way the device avoids contamination of subsequently used fluids in the device. Furthermore, in some embodiments it is possible to conduct several analyses in parallel, even if the analyses differ, e.g. in that different analytes are determined or in that the chemical reactions performed are different.

The following examples are offered to illustrate, but not to limit the claimed invention.

### EXAMPLES

### Example 1

Manufacture of a Device According to the Invention

a) A device as shown in FIG. 1a is prepared as follows:

A two-part mould reflecting the outer form of the device according to FIG. 1a is filled with polypropylene (Handbuch Spritzgieβen, 2004, Hanser Verlag, page 77) (Werkstoff-Führer Kunststoffe, 2001, 8. Auflage Hanser Verlag, pages 83-89).

The large chamber has in its lower part a tubular section (diameter: 14 mm, height: 40 mm). The angle at the bottom is 65°. After solidification, a foil of polypropylene (30 μm) and aluminum (110 μm) is welded by thereto welding to the polypropylene body. The outlet openings are closed by silicon stoppers.

b) The insert as shown in FIGS. 1(a-c) is produced from a slightly elastic polymer by injection moulding (diameter including the ribs: 14 mm, height of the ribs: 12 mm, channel width: 0.8 mm, same lower angle as the device). The insert is inserted into the upper part of tubular part of the chamber of the device as manufactured under a).

c) A glass fiber fleece is inserted in the second chamber. The device is then sealed with the sealing foil (heat transfer foil).

### Example 2

### Performance of a Process Including Sample Preparation and PCR and Detection in One Device of Example 1a

In the first step, the device manufactured as in Example 1 is loaded into the process station of the instrument. This is done using grippers engaging into recesses on the upper part of the device (see FIG. 1(a-c), reference numeral 8). Then a quantization standard solution is added to each of the first chambers (see 3) using a head bearing 8 pipette tips. The tips are discarded. Then a lysis solution containing proteinase K is added to the chambers, again using parallel pipetting. Then, using fresh pipette tips, an aliquot of 7 samples and one negative control is added to each of the first chambers. The tips are used for mixing the solution by sipping and spitting the mixtures within each chamber to mix thoroughly. The mixtures are then incubated for 10 mm at 72° C. to lyse, while the tips remain in the first chambers.

Then pressure is put onto the system to transport the mixture through the outlet portion (see 4) of the first chamber into the second chamber (see 5), filled with glass fleece. Any nucleic acids get bound to the glass surface, while the liquid is removed through the outlet port. A hollow steel needle is docked onto the outlet port to withdraw the liquid. Then the pipette tip is moved downwards until the lower conical part of the insert touches the conical part of the bottom of the chamber of the device. Thereby the insert is pushed towards the bottom thus leaving only the channel in the interior of the insert for liquids to pass the outlet opening of the chamber. Several drops of fluid from the walls of the lysis chamber move from the walls towards the bottom and are retained in the recesses of the insert.

After removal of the pipette tip, washing liquid (400 μl) is pipetted into the conical part of the inserts using a new set of pipette tips, and is sucked through the second chamber, thus removing impurities from the nucleic acids bound. This is repeated 3 times.

Aliquots of an elution buffer (70 μl) are added to the conical part of the inserts in the first chambers and pipetted through the fluidic units so that the eluted liquids remain in the third chambers.

The liquids in the third chambers are subjected to the following thermal cycles:

1^{st} Cycle:

| | | |
|---|---|---|
| 50° C. | 120 sec | UNG-Step |

5 Cycles:

| | | | |
|---|---|---|---|
| +4° C./sec 95° C. | 15 sec | Denaturation | |
| −4° C./sec. 59° C. | 50 sec | Annealing & | measurement after 35 sec |
| | | fluorescence | |

45 Cycles:

| | | | |
|---|---|---|---|
| +4° C./sec 91° C. | 15 sec | Denaturation | |
| −4° C./sec 52° C. | 50 sec | Annealing & | measurement after 35 sec |
| | | fluorescence | |

Light of the wavelengths of the excitation wavelengths of the probes is impinged into each third chamber and fluorescence is measured in the third chambers during irradiation during the annealing phase in each cycle. Using the quantization standard, the amount of nucleic acids in each sample is determined according to standard calculations. The 8^{th} sample is used as a negative check.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. An analytical device comprising a body comprising a fluidic unit comprising
a) a first chamber having an outlet opening, and
b) a first channel exiting said outlet opening,
wherein said first chamber further contains an insert comprising recesses between ribs touching the walls of said first chamber and a second channel, said insert being located in a first position wherein said insert is not engaged with said outlet opening, said insert being moveable from said first position to a second position within said first chamber, wherein said insert is engaged with said outlet opening such that said second channel extends said first channel into said first chamber and in the part pointing towards said outlet opening resembles the shape of said chamber.

2. The device according to claim 1, wherein said outlet opening broadens conically from said first channel into said first chamber.

3. The device according to claim 1, wherein, when said insert is in said first position, fluid can pass through said second channel and through said recesses of said insert into said first channel through said outlet opening.

4. The device according to claim 1, wherein, when said insert is in said second position, fluid can pass said insert towards said outlet opening through said second channel and can pass said recesses, but cannot enter into said first channel when having passed said recesses.

5. The device according to claim 1, wherein said insert further comprises a conical part at the end of the second channel pointing away from said outlet opening.

6. The device according to claim 1, wherein the volume of fluid that cannot enter the outlet opening of said first chamber when said insert is in said second position is between 5 and 1000 μl.

7. An analytical instrument comprising
a fitting for holding a device according to claim 1; and
a head comprising an actuator reaching into the device and having a freedom to move the insert from said first position to said second position.

8. The instrument according to claim 7, wherein further comprising two or more pipette tips mounted on sockets, said pipetting tips having an outlet opening having an outer conical shape.

9. A system for analysis of a fluid in a device, comprising
a device according to claim 1, and
an instrument according to claim 7.

10. The system according to claim 9 further comprising a fluid dispensing unit.

11. A method for analyzing a fluid comprising using a device according to claim 1.

12. A method of analysis of components of a fluid comprising
providing a device according to claim 1 or a system according to claim 9, and
introducing a fluid into said first chamber,
releasing said component of said fluid from other components of said fluid this component is associated with in said first chamber,
transferring the resulting fluid through said outlet opening and said first channel into said second chamber, said second chamber containing a solid phase for immobilization of said component to be analyzed, thereby binding said component to said solid phase,
moving said insert towards said outlet opening into said second position such that fluid can pass said insert towards said outlet opening through said second channel and can be caught in said recesses, but cannot enter into said first channel when being trapped in said recesses
introducing a second fluid into said second chamber through said second channel.

13. The method according to claim 12, wherein said second fluid is introduced through a pipette tip docketed into the second channel of said insert in a fluid tight manner.

14. The method according to claim 12, wherein said second fluid is a washing buffer.

15. The method according to claim 12, further comprising introducing a third fluid into said second chamber through said second channel.

16. The method according to claim 12, further comprising removing said third fluid from said second chamber together with said component into a third chamber,
thermally treating said third fluid containing said component in said third chamber.
